(19) United States
(12) Patent Application Publication
(10) Pub. No.: US 2009/0126720 A1
(43) Pub. Date: May 21, 2009

(54) SUGAR CANE JUICE CLARIFICATION PROCESS

(75) Inventors: Fabio Alessio Romano Dionisi, Sao Paulo (BR); Rafael Januario Calabrese, Sao Paulo (BR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. du Pont de Nemours and Company, Wilmington, DE (US)

(21) Appl. No.: 12/203,238

(22) Filed: Sep. 3, 2008

Related U.S. Application Data
(60) Provisional application No. 61/003,342, filed on Nov. 16, 2007.

(51) Int. Cl. C13D 3/16

(52) U.S. Cl. 127/57

(57) ABSTRACT

A process to clarify raw sugar cane juice, which comprises adding a source of lime, adding an anionic inorganic colloid, and separating of the resulting sugar cane juice, is disclosed.

### FIELD OF THE INVENTION

The invention refers to an enhanced process to clarify raw sugar cane juice by means of the use of an anionic inorganic colloid.

### BACKGROUND OF THE INVENTION

Sugar cane juice is an extremely complex liquid medium, containing many organic and inorganic constituents in soluble, suspended/decantable and suspended/colloidal form. Cane sugar for human consumption is produced by means of clarification of sugar cane juice using an extraction process, which is then processed and concentrated to obtain sugar.

Clarification is therefore an essential step to obtain high yields and high quality of the sugar. The clarification process needs to remove components other than sucrose and, at the same time, minimize loss of sucrose and color formation.

Three of the types of sugar that are currently manufactured include raw sugar, refinery sugar, and crystal sugar. For the production of crystal sugar, sulfitation is currently the most widely used process to clarify cane juice. It consists of SO₂ (sulphur dioxide) absorption by the juice.

Another method to clarify sugar cane juice in the manufacture of crystal sugar is carbonation, which generally employs treatment with lime and controlled addition of carbon dioxide (CO₂). However, these processes are typically not used in the manufacture of raw sugar or refinery sugar due to their complexity and expense.

Silicate microgels are used in water purification and water flow processes. U.S. Pat. No. 6,132,625 discloses a process to clarify water streams containing biosolids resulting from processing food and organic residues, which comprises contact of the stream with an anionic colloid, which may be a silicate microgel, and an organic polymer to flocculate the biosolids.

During the manufacture of raw sugar and refinery sugar the removal of dextran, starch, and sources of color is difficult and costly. Therefore, there is a desire to have an enhanced clarification process for use in the manufacture of raw sugar and refinery sugar which removes excess dextran and starch while minimizing color formation, and which is simple, efficient and economical. The process of the present invention resolves this problem.

### SUMMARY OF THE INVENTION

The invention comprises a sugar cane juice clarification process comprising at least the steps of addition of lime; addition of anionic inorganic colloid, and separation of the resulting sugar cane juice.

More specifically, the invention comprises an improved process to clarify sugar cane juice comprising the addition of an anionic inorganic colloid, according to the following steps:
a) heating of the raw sugar cane juice to be clarified;
b) adding a source of lime;
c) adding an anionic inorganic colloid; and
d) decanting precipitates formed to yield a supernatant containing sugar cane juice.

The process optionally further comprises:
a) heating of the supernatant from step d) above; and
b) decanting any precipitates formed to yield a further supernatant containing sugar cane juice.

### DETAILED DESCRIPTION OF THE INVENTION

According to a specific embodiment of the invention, the clarification process of the present invention comprises the steps of:
a) heating of the raw sugar cane juice to be clarified;
b) adding a source of lime;
c) adding an anionic inorganic colloid,
d) decanting precipitates formed to yield a supernatant containing sugar cane juice.

In particular, the present invention provides an improved process for clarifying raw sugar cane juice using wherein the improvement comprises addition of an anionic inorganic colloid. The preferred anionic inorganic colloid is silicate microgel. This process is for the manufacture of raw sugar or refinery sugar and does not use sulfitation or carbonation. The present invention further comprises a process wherein steps b) through d) listed above are repeated in subsequent stages in a multi-stage decantation process.

During step a), raw sugar cane juice is heated to a temperature between about 65° C. and about 115° C., preferably between about 80° C. and about 115° C., and still more preferably between about 85° C. and about 110° C. Juice heating has the purpose of facilitating downstream processes by speeding up chemical reactions and improving the coagulation and sedimentation of colloids and others non-sugars.

The liming step b) is the addition of a source of lime (CaO) to the raw cane juice. Any suitable source of lime can be employed, but lime milk (Ca(OH)₂) or calcium saccharate are preferred. The addition of the source of lime raises the pH of the sugar cane juice. Lime is added up to a maximum concentration of about 2% by weight of the solids content of the juice. This addition has the purpose of eliminating juice colorants, neutralizing organic acids, and forming calcium phosphate precipitate, which upon sedimentation carries with it the impurities present in the liquid.

Between steps b) and c), it is particularly advantageous that a time interval of between about 0.5 and about 10 minutes is optionally observed.

In step c) of the process of the present invention an anionic inorganic colloid is added. Such colloids useful in the process of this invention include silica-based anionic inorganic colloids and mixtures thereof. Silica-based anionic inorganic colloids include, but are not limited to, colloidal silica, aluminum-modified colloidal silica, polysilicate microgels, polyaluminosilicate microgels, polysilicic acid, and polysilicic acid microgels, and mixtures thereof. For those colloids containing aluminum, the aluminum can be on the surface and/or in the interior of the particles.

The anionic inorganic colloids used in this invention can be in the form of a colloidal silica having an S value greater than 70%, generally greater than 75%, and containing about 2 to 60% by weight of SiO₂, preferably about 4 to 30% by weight of SiO₂. The colloid can have particles with at least a surface layer of aluminum silicate or it can be an aluminum modified silica sol. The alumina content of the surface-modified silica sol can be in the range of 2 to 25%. The colloidal silica particles in the sols commonly have a specific surface area of 50-1200 m²/g, more preferably about 200-1000 m²/g. The silica sol can be stabilized with alkali in a molar ratio of SiO₂:M₂O of from 10:1 to 300:1, preferably 15:1 to 100:1, and most preferably 6:1 to 12:1 (M is Na, K, Li, or NH₄).

Preferred for use in the process of the present invention are silicate microgels. Microgels are distinct from colloidal silica in that the microgel particles usually have surface areas of 1000 m²/g or higher, preferably 1100 m²/g or higher, and more preferably 1200 m²/g or higher. The microgels are comprised of small 1-2 nm diameter silica particles linked together into chains and three-dimensional networks. Polysilicate microgels, also known as active silicas, have SiO₂:Na₂O ratios of 4:1 to about 25:1, and are discussed on pages 174-176 and 225-234 of “The Chemistry of Silica” by Ralph K. Iler, published by John Wiley and Sons, N. Y., 1979. Polysilicic acid generally refers to those silicic acids that have been formed and partially polymerized in the pH range 1-4 and comprise silica particles generally smaller than 4 nm diameter, which thereafter polymerize into chains and three-dimensional networks. Polysilicic acid can be prepared in accordance with the methods disclosed in U.S. Pat. Nos. 5,127,994 and 5,626,721. Polyaluminosilicates are polysilicate or polysilicic acid microgels in which aluminum has been incorporated within the particles, on the surface of the particles, or both. Polysilicate microgels, polyaluminosilicate microgels and polysilicic acid can be prepared and stabilized at acidic pH. Microgel size can be increased by any of the known methods such as of aging of the microgel, changing pH, changing concentrations, or other methods, known to those skilled in the art. The use of silicate microgels provides the advantage in the process of the present invention of reducing scaling in equipment, and therefore equipment and maintenance cleaning problems.

The polysilicate microgels and polyaluminosilicate microgels useful in this invention are commonly formed by the activation of an alkali metal silicate under conditions described in U.S. Pat. Nos. 4,954,220 and 4,927,498. However, other methods can also be employed. For example, polyaluminosilicates can be formed by the acidification of silicate with mineral acids containing dissolved aluminum salts as described in U.S. Pat. No. 5,482,693. Alumina/silica microgels can be formed by the acidification of silicate with an excess of alum, as described in U.S. Pat. No. 2,234,285.

In addition to conventional silica sols and silica microgels, silica sols such as those described in European patents EP 491879 and EP 502089 can also be used for the anionic inorganic colloid in this invention. These are commonly referred to as low “S value” sols. EP 491879 discloses a silica sol having an S value in the range of 8 to 45% wherein the silica particles have a specific surface area of 750 to 1000 m²/g, which have been surface-modified with 2 to 25% alumina. EP 502089 discloses a silica sol having a molar ratio of SiO₂ to M₂O, wherein M is an alkali metal ion and/or an ammonium ion of 6:1 to 12:1 and containing silica particles having a specific surface area of 700 to 1200 m²/g.

Included within the scope of colloidal silica sols useful in the present invention are colloidal silica sols having a low “S value”. S value is defined by Iler and Dalton in J. Phys. Chem., 1956, vol. 60, pp. 955-957. S value is a measure of the degree of aggregate or microgel formation and a lower S value indicates a higher microgel content and is determined by the measure of the amount of silica, in weight percent, in the disperse phase. The disperse phase consists of particles of anhydrous silica together with any water that is immobilized at the surface or in the interior of the particles.

In the process of the present invention the preferred silicate microgel is added to the mixture of sugar cane juice and lime source in step c), preferably at a quantity of between about 50 microgram/g (ppm) and about 500 microgram/g (ppm), more preferably from about 50 microgram/g (ppm) to about 200 microgram/g (ppm). Silicate microgels are commercially available, such as Particlear® manufactured by E. I. du Pont de Nemours and Company of Wilmington Del., and are produced by any method known in the art. U.S. Pat. No. 6,060,523 and U.S. Pat. No. 6,274,112 disclose enhanced processes allowing reliable preparation of the microgels. Silicate microgel typically is obtained from sodium silicate. It is also designated as silicon dioxide microgel or active silica, comprising between about 0.5% and 2% SiO₂, particularly about 1% SiO₂ solution.

Applicant has developed an enhanced clarification process for cane juices which is particularly useful for the manufacture of raw sugar or refinery sugar. The process comprises the addition of an anionic inorganic colloid, preferably silicate microgel, and adjusting it to the operating conditions of a manufacturing facility. The present invention thus solves the problems of the difficulty of removal of dextran and starch from the raw sugar cane juice. The process of the present invention lowers scale formation in evaporators and heat-exchangers by removal of scale forming compounds from the juice through the improved clarification process. Furthermore, the process of the present invention solves the problem of filtering the precipitates/sedimentation generated by the traditional processes.

The process of the present invention obtains better purification of the cane juice by removal of more organic and inorganic impurities.

According to a preferred embodiment of the invention, the microgel is activated by an acid. A time interval between step b) and the subsequent one is advantageous and this time interval is typically between 0.5 and about 10 minutes.

After treatment with the microgel the decanting is undertaken. In step d), the sugar cane juice is purified by removing precipitated impurities as solids. The decanted juice is removed from the upper part of the decanter and delivered to an evaporator, where it is concentrated. The precipitated and sedimented materials are usually taken from the bottom of the decanter and sent to a filtering sector where the materials are subsequently filtered to recover sugar. According to the invention, the required decanting time is less than one hour, usually about 30 minutes.

The present invention further comprises a process which, in addition to the above-disclosed steps, additionally comprises the following steps for each subsequent stage in a multi-stage decantation process:
a) heating of supernatant resulting from the above-described process;
b) adjusting the pH to from about 6.5 to about 9;
c) adding an anionic inorganic colloid; and
d) decanting any solids precipitated to yield a further supernatant containing sugar cane juice.

During step a), the supernatant is heated at temperatures between about 60° C. and 90° C., preferably about 70° C. Operating conditions are employed which avoid excessive foam formation and which generate the expected neutral pH for the juice. The final pH is typically from about 6.5 to about 9, preferably about from about 6.5 to about 9. The anionic inorganic colloid is as previously described above. Any solids precipitated are decanted to yield a further supernatant containing sugar cane juice. The invention further comprises a process which, in addition to the first described process above, includes only steps a) and d) above.

The process of the present invention results in a high removal of non sugars such as starches, proteins, solids in suspension and dissolved solids. The protein and starch are surprisingly reduced, typically to less than about 200 microgram/g (ppm) in the clarified juice. The process of the present invention thus yields purer product. Preferably the process of the present invention is used in the manufacture of raw sugars.

The lower quantity of impurities is very desirable and benefits the whole operation, since it reduces the overall volume to be processed throughout the system. Therefore, there is less incrustation/scaling in the heating equipment, especially the evaporator, which then does not need to be cleaned so frequently. This reduces maintenance and steam energy costs and increases safety for employees who conduct such cleaning operations at the industrial facility. For all of the above reasons, the process provides increased efficiency overall. Fewer impurities are processed under the same installed capacity, thus increasing sugar production.

In addition to the above advantages, the process of the present invention improves the reduction of juice turbidity, reduction of organic colloids (e. g., starch), and improved coagulation and flocculation. In particular, the time to form flakes is reduced and the size of the flakes is reduced. Thus sedimentation time is reduced overall. A further advantage is the optional elimination of the addition of flocculating agents.

The fact that the new process generates precipitates/sediment with easier filtering characteristics than traditional processes is exceptionally advantageous to the sugar/alcohol industry. The sediment resulting from traditional processes is difficult to filter, requiring the installation of pressing filters, representing a large financial investment and a more complicated process. The process of the present invention generates precipitates/sediment which does not require the installation of press filters, since vacuum rotating filters can be used.

Thus, the process of the invention is a faster and safer process, results in a significant increase in yield, generates superior quality, and avoids the problems in conventional processes. It is useful to clarify sugar cane juice more efficiently.

As the experts in the art will realize, numerous modifications and variations of the scope of the invention are possible in the light of the above teachings. It should therefore be understood that the invention can be embodied in other ways besides those specifically described herein.

### EXAMPLES

Raw sugar cane juice from past crop seasons typically had the following properties: pH of 5.2-5.8, turbidity of 5000, and color of 10,000 to 12,000 using the ICUMSA Method #4.

### Example 1

Raw sugar cane juice was processed continuously in a sugar mill plant. Raw sugar cane juice was heated to 85° C., followed by gradual addition of liming milk (calcium hydroxide, Ca(OH)₂) to raise the pH to 8.5. Liming milk consumption was about 1.2% CaO by weight on solids content. The solution was maintained for about five (5) minutes and 160 microgram/g (ppm) silicate microgel available as Particlear® from E. I. du Pont de Nemours and Company, Wilmington, Del. was added. The solution was then held for about 5 minutes. The pH of the solution was kept at 8.5 via addition of liming milk. After 15-30 minutes, the pH of the solution was lowered to 6.5 by addition of acid. The juice was then sent to a decanter (chamber tank) in order to separate the precipitate from the clarified juice (supernatant). The insoluble particles were allowed to settle for 45 minutes. The supernatant from the decanter was sent to evaporators. The resulting juice was sent for characterization and the results are given in Table 1 below.

### Comparative Example A

Sugar cane juice was processed in the mill using the procedure of Example 1 but without the addition of the silicate microgel. The coagulated precipitate was separated from the supernatant. Data on the resulting product is listed in Table 1 below.

Table 1 compares the properties of the sugar juice made using the process of the present invention to the same process without use of the silicate microgel (Comparative Example A).

TABLE 1

| | Comparative | |
|---|---|---|
| Attribute | Example A | Example 1 |
| pH | 7.0 | 8.5 |
| Color ICUMSA, | 1200 | 252 |
| UI | | |
| Starch | 180 | 103 |
| Dextran, mg/kg | 150 | 75 |
| Turbidity | 20 | 10 |

Table 1 shows improvement in color, starch, dextran and turbidity using the process of the present invention.

### Example 2

Several plant runs were conducted in an eight day mill trial in accordance with the procedure of Example 1.

The reduction of dextran and starch using the process of the present invention is shown in Table 2 comparing the raw sugar juice and the clarified juice.

TABLE 2

| | Raw | Clarified | Raw | Clarified |
|---|---|---|---|---|
| | Juice | Juice | Juice | Juice |
| Day | Starch | Starch | Dextran | Dextran |
| 1 | 285 | 151 | 173 | 81 |
| 2 | 413 | 190 | 94 | 48 |
| 3 | 434 | 187 | 81 | 42 |
| 4 | 328 | 184 | 49 | 42 |
| 5 | 445 | 178 | 53 | 47 |
| 6 | 440 | 134 | 47 | 43 |
| 7 | 440 | 138 | 83 | 43 |
| 8 | 291 | 146 | 50 | 42 |

The data in Table 2 showed significant reduction in starch and dextran using the process of the present invention.

The data in Table 3 showed microgram per gram starch and dextran on solids basis in the raw juice and final raw sugar on a daily average basis during the eight day trial using the present invention.

TABLE 3

| | Raw | Final | Raw | Final |
|---|---|---|---|---|
| | Juice | Sugar | Juice | Sugar |
| Day | Starch | Starch | Dextran | Dextran |
| 1 | 1759 | 267 | 1068 | 633 |
| 2 | 2344 | 182 | 533 | 235 |
| 3 | 2438 | 192 | 455 | 105 |
| 4 | 1882 | 158 | 281 | 58 |
| 5 | 2530 | 197 | 301 | 60 |
| 6 | 2628 | 194 | 281 | 39 |
| 7 | 2614 | 272 | 493 | 34 |
| 8 | 1780 | 174 | 306 | 30 |

Results in Table 3 show that dextran and starch were significantly reduced using the process of the present invention.

Table 4 shows the color of raw juice and final raw sugar on a daily average basis during the eight day trial using the process of present invention.

TABLE 4

| | Raw | Final |
|---|---|---|
| Day | Juice | Sugar |
| 1 | 13762 | 269 |
| 2 | 13006 | 298 |
| 3 | 11832 | 259 |
| 4 | 12509 | 212 |
| 5 | 11981 | 218 |
| 6 | 12036 | 247 |
| 7 | 13752 | 267 |
| 8 | 11927 | 242 |

The data in Table 4 shows that color was significantly reduced using the process of the present invention.

What is claimed is:

1. A process to clarify raw sugar cane juice, without sulfitation or carbonation, comprising the steps of addition of a source of lime; addition of an anionic inorganic colloid, and separation of the resulting sugar cane juice.

2. The process of claim 1 comprising the following steps:
a) heating of the raw sugar cane juice to be clarified;
b) adding a source of lime;
c) adding an anionic inorganic colloid; and
d) decanting precipitates formed to yield a supernatant containing sugar cane juice.

3. The process of claim 1 further comprising the following additional steps:
a) heating of the supernatant;
b) adjusting the pH to from about 6.5 to about 9;
c) adding an anionic inorganic colloid; and
d) decanting any solids precipitated to yield a further supernatant containing sugar cane juice.

4. The process of claim 2 wherein the anionic inorganic colloid is a silicate microgel.

5. The process of claim 2 wherein the raw sugar cane juice is heated at a temperature between about 65° C. and about 115° C.

6. The process of claim 2 wherein the lime is added to the raw cane juice to achieve a maximum concentration of 2% by weight of solids of the raw cane juice.

7. The process of claim 2 wherein the lime is in the form of lime milk (Ca(OH)₂) or calcium saccharate.

8. The process of claim 2 wherein the silicate microgel is added in an amount from about 50 ppm to about 500 ppm.

9. The process of claim 4 wherein the addition of silicate microgel is conducted after a period of from about 0.5 to about 10 minutes after adding lime.

10. The process of claim 2 wherein decanting time is less than one hour.

11. The process of claim 2 wherein the final pH of the supernatant is from about 6.5 to about 8.

12. The process of claim 3 wherein the anionic inorganic colloid is a silicate microgel.

13. The process of claim 3 wherein the raw sugar cane juice is heated at a temperature between about 60° C. and about 90° C.

14. The process of claim 3 wherein the lime is added to the raw cane juice to achieve a maximum concentration of 2% by weight of solids of the raw cane juice.

15. The process of claim 3 wherein the lime is in the form of lime milk (Ca(OH)₂) or calcium saccharate.

16. The process of claim 3 wherein the silicate microgel is added in an amount from about 50 ppm to about 500 ppm.

17. The process of claim 3 wherein the addition of silicate microgel is conducted after a period of from about 0.5 to about 10 minutes after adding lime.

18. The process of claim 3 wherein decanting time is less than one hour.

19. The process of claim 3 wherein the final pH of the supernatant is from about 6.5 to about 8.

20. The sugar cane juice produced by the process of claim 1.
